(19) United States
(12) Patent Application Publication
(10) Pub. No.: US 2008/0102182 A1
(43) Pub. Date: May 1, 2008

(54) Baked Nut Snack Chip

(76) Inventors: Carol McCall, McKinney, TX (US); Christina Snider Malvaiz, Frisco, TX (US); Mohan Rao, Plano, TX (US)

Correspondence Address: Colin P. Cahoon;CARSTENS & CAHOON, LLP, P.O. Box 802334, Dallas, TX, 75380, US

(21) Appl. No.: 11/553,648

(22) Filed: Oct. 27, 2006

(51) Int. Cl. A21D 10/00; A21D 13/00

(52) U.S. Cl. 426/549; 426/632

(57) ABSTRACT

The present invention discloses formulations for sheeted, baked nut-based snack chips that have a crispy, crunchy texture. Ingredient formula ranges have been determined that provide improved dough cohesiveness during processing, and improved flavor, texture, appearance and structural integrity of the finished snack chip. The dry ingredients are combined with water to make a dough, which is then sheeted and cut into pieces. The pieces are baked to produce nut-based snack chips.

### BACKGROUND OF THE INVENTION

1. Technical Field

The present invention relates to a method for making an improved baked snack food and, more particularly, to a method for making a baked, sheeted snack food having high contents of visible nut pieces, a crispy, crunchy texture, and a good source of protein.

2. Description of Related Art

Snack items are an important consumer item for which there exists a great demand. Snacks can also play a large role in the diet of consumers. Peanuts and other types of nuts are a preferred snack item because they are nutritious due to their high protein content. Many nuts also have high fiber content, which has been attributed to reducing a person's risk of certain cancers, diabetes, digestive disorders, and heart diseases. Fiber may also help people control obesity, because insoluble fiber is not digested and passes through the digestive system virtually intact, providing bulk but very few calories. Studies have also shown that people who consume nuts on a regular basis are less likely to suffer from coronary heart disease and can lower their LDL cholesterol levels, probably due to the fatty acid profile of nuts.

Although many nuts can be consumed in their unprocessed or natural form, a demand exists for snacks in chip form, like potato chips. It is desirable, therefore, to provide consumers with a nut-based snack chip that is produced from a sheeted dough.

A healthy, nutritious snack chip should ideally meet several criteria. Preferably, the criteria should also include products formulated to have specific health or wellness benefits. The Food and Drug Administration (FDA) allows manufacturers to make a nut health claim on products meeting certain criteria. Specifically, a nutritious snack meets the FDA's requirements for a nut health claim by having, per 30 gram serving, at least 11 grams of nuts, less than 7.5 grams of fat, no more than 1 g saturated fat, no more than 270 mg sodium, no more than 20 mg cholesterol, and at least 10% recommended daily value for vitamin A, vitamin C, iron, calcium, protein or dietary fiber. The FDA's nut health claim reads as follows: “Scientific evidence suggests but does not prove that eating 1.5 ounces per day of most nuts [such as name of specific nut] as part of a diet low in saturated fat and cholesterol may reduce the risk of heart disease. [See nutrition information for fat content.]”.

There have been prior attempts to produce sheeted nut-based snack chips, but none have used an appropriate mixture of binder ingredients and nuts to produce a snack chip with visible pieces of nut particles and a crunchy, crispy finish that can maintain its structural integrity during transport, while also meeting the preferred nutritional criteria listed above. A need, therefore, exists for a nut-based snack chip with a crunchy, crispy texture with high nutritional value.

### SUMMARY OF THE INVENTION

The present invention provides a great tasting, healthy snack chip having a high content of visible nut pieces, a crispy, crunchy texture, and improved structural integrity. The snack chip of the present invention preferably has at least about 40% nuts, a final moisture content of about 1.5% by weight, and satisfies the FDA nutritional criteria to make a nut health claim. In one aspect of the invention, chopped or sliced nut pieces are used as a healthy ingredient in the sheeted, backed snack chips of the present invention. The nuts provide good taste, texture, appearance and nutritional benefits to the consumer. A defined nut particle size distribution or nut slice thickness is carefully chosen to ensure adequate incorporation of the nuts with the binder ingredients and the ability to process the dough. In yet another aspect of the invention, a mixture of binder ingredients is used as an essential ingredient. The binder is a blend of starches, wheat flour, and wheat gluten that, when used in the combinations disclosed herein, gives the dough its cohesiveness needed for processing and gives the final snack chips their crunchy, crispy texture. The types and quantities of these dry binder ingredients, the chosen nut particles or slices, along with proper oven conditions deliver the desired light and crispy texture. These as well as additional features and advantages of the present invention will become apparent in the following written description.

### BRIEF DESCRIPTION OF THE DRAWINGS

The novel features believed characteristic of the invention are set forth in the appended claims. The invention itself however, as well as a preferred mode of use, further objectives and advantages thereof, will be best understood by reference to the following detailed description of illustrative embodiments when read in conjunction with the accompanying drawings, wherein:

FIG. 1 is a flowchart indicating the processing steps for the present invention.

### DETAILED DESCRIPTION

The snack chips of the present invention are nut-based snacks that contain nut pieces and a binder material, and which take the final form of a baked snack chip having a crunchy, crispy texture. The nutritional goals for the snack chips of the present invention include, per 30 gram serving of snack chips: at least 1 grams of nuts, less than 7.5 grams of fat, no more than 1 gram of saturated fat, no more than 270 milligrams of sodium, no more than 20 milligrams of cholesterol, and at least 10% FDA recommended daily value (DV) of protein. By satisfying the foregoing criteria, the snack chips of the present invention can be sold under an FDA qualified nut health claim.

The FDA recommended daily value of dietary fiber, protein, vitamin A, vitamin C, calcium and iron, based on a 2000 calorie per day diet, can be found in the FDA Nutrition Labeling Manual, 1998 Edition, available at http://www.cfsan.fda.gov/˜dms/nutrguid.html, which is incorporated herein by reference. These values are summarized in the following table:

TABLE I

| Food Component | DV | |
|---|---|---|
| Dietary Fiber | 25 | g |
| Protein | 50 | g |
| Vitamin A | 5,000 | IU |
| Vitamin C | 60 | mg |
| Calcium | 1,000 | mg |
| Iron | 18 | mg |

### Therefore, to fulfill the 10% DV of protein criterion in the nutritional goals of the present invention, the snack chips should have at least 5 grams of protein.

As used herein, the term “nut” is used in the culinary sense and includes any large, oily kernel found within a shell and used in food. Examples of nuts include, without limitation, peanut, almond, pistachio, cashew, Brazil nut, pecan, hazelnut and walnut. The following disclosure will focus on peanut, almond and pistachio snack chips, but this not intended to limit the scope of the invention as other varieties of nuts fall within the teachings disclosed herein. The nuts used herein are preferably full-fat nuts, but the principles disclosed herein apply equally as well to other nuts, including nuts that are chopped or sliced, oil-roasted, dry-roasted, raw, blanched, unblanched, salted or unsalted, full-fat or partially defatted.

The snack chips of the present invention are preferably prepared with chopped nut pieces having a distinct particle size distribution profile. The particle size distribution profile for the chopped nut pieces affects the incorporation of the nut particles into the dough, the cohesiveness of the dough sheet, and the final product appearance, flavor and texture. For example, if the chopped nut pieces are too large, the required amount of nuts to meet the nut health claim cannot be incorporated successfully into the dough and the dough cannot be sheeted without experiencing holes in the sheet and compromising finished product appearance and integrity. If the chopped nut pieces are too small, the nut identity is lost and the finished product texture becomes more dense, less expanded, and “cracker-like”. In the case of peanuts, the presence of small nut particles can create a flavor more like peanut butter and less like the actual peanuts themselves. Consequently, when using chopped nut pieces, particle size distribution is important in obtaining the desired finished product in the present invention.

The snack chips of the present invention are also preferably prepared using sliced nuts as an ingredient. The thickness of each nut slice should not exceed the thickness of the raw sheeted dough. If the slices are too large, a cohesive dough, without holes, may not be formed, thus compromising the finished product appearance and integrity. If the slices are too thin, they cannot withstand handling and processing, and do not maintain their slice integrity. It has been determined that using nut slices (such as peanut, almond or pistachio slices) as an ingredient in the snack chips of the present invention results in increased structural integrity and enhanced visual appearance in the finished product.

In one preferred embodiment, full fat, dry roasted blanched peanuts are used. The ranges of preferred particle size distribution for the peanut pieces is summarized as follows: about 5% to about 60% pass through a U.S. #6 mesh screen, about 20% to about 40% pass through a U.S. #8 mesh screen, about 20% to about 35% pass through a U.S. #10 mesh screen. A more preferred particle size distribution profile for the peanut pieces is summarized as follows: about 52% pass through a U.S. #6 mesh screen, about 25% pass through a U.S. #8 mesh screen, and about 23% pass through a U.S. #10 mesh screen.

All percentages used herein are by weight unless otherwise noted. All mesh screen sizes as used herein are based on the U.S. Sieve scale. The opening sizes for the U.S. Sieve scale are summarized in the following table:

TABLE II

Opening Size

| U.S. Sieve # | Millimeters | Inches |
|---|---|---|
| 4 | 4.76 | 0.187 |
| 5 | 4.00 | 0.157 |
| 6 | 3.36 | 0.132 |
| 7 | 2.83 | 0.111 |
| 8 | 2.38 | 0.0937 |
| 10 | 2.00 | 0.0787 |
| 12 | 1.68 | 0.0661 |
| 14 | 1.41 | 0.0555 |
| 16 | 1.19 | 0.0469 |

In another preferred embodiment, peanut slices are used. The peanut slices have a preferred thickness between about 0.043 inches and about 0.060 inches.

In another preferred embodiment, full fat, raw, diced pistachio nuts are used. The ranges of preferred particle size distribution for the chopped pistachio pieces is summarized as follows: about 30% to about 60% pass through a U.S. #6 mesh screen, about 30% to about 50% pass through a U.S. #8 mesh screen, and about 10% to about 30% pass through a U.S. #10 mesh screen. A more preferred particle size distribution profile is summarized as follows: about 40% pass through a U.S. #6 mesh screen, about 40% pass through a U.S. #8 mesh screen, and about 20% pass through a U.S. #10 mesh screen. In another preferred embodiment, sliced pistachio nuts are used. The pistachio nut slices have a preferred thickness between about 0.043 inches and about 0.060 inches.

In still another preferred embodiment of the present invention, full fat, raw sliced almonds are used. The almonds are preferably slices between about 0.043 inches and about 0.060 inches in thickness.

All of the foregoing particle size distributions have been found to produce a dough with sufficient binding capability to practice the present invention and a snack chip having a desired taste and crispy, crunchy texture. However, the particle size distributions listed above are not intended to limit the scope of the present invention in its broadest sense as other particle size distributions are possible within the teachings disclosed herein.

To produce a nut-based snack chip dough with sufficient cohesiveness to be sheeted and cut into snack sized pieces, and a final snack chip with the desired crispy, crunchy texture with structural integrity, the nut pieces are mixed with a binder mixture and water to form a dough. The binder mixture is comprised of dry dough ingredients that help maintain dough cohesiveness and expansion during cooking, and contribute to the final product crunchy, crispy texture and enhanced flavor, among other things. These particular ingredients and ratios were selected not only for their binding and structural properties, but also for meeting the nut health claim criteria as outlined previously.

In one embodiment wheat flour is included in the binder mixture in the dough to maintain the dough cohesiveness, contribute to the final product texture and reduced breakage of the final product, thereby improving its structural integrity. Preferably, the wheat flour is White Pastry EZ flour available from Con Agra Foods, located in Omaha, Nebr., but can be any pastry wheat flour. Pastry flour has slightly higher levels of gluten content than cake flour, but lower levels of gluten than all-purpose flour. Although pastry wheat flour is preferred, other flours such as oat flour or rye flour may also be used in combination or in place of wheat flour.

In another embodiment, modified waxy corn starch is included as an ingredient in the binder mixture. Waxy corn starch is a starch that is high in amylopectin. Amylopectin is a branch-chained polysaccharide, whereas the other component of most starches, amylose, is a straight-chained polysaccharide. The starch used in the present invention is preferably waxy corn starch. While normal corn starch typically has a ratio of about 25% amylose to about 75% amylopectin, waxy corn starch contains about 100% amylopectin. The waxy starch used in the present invention preferably contains about 100% amylopectin starch and about 0% amylose starch. The modified waxy corn starch is used in the present invention to help with final product expansion, dough cohesiveness and a resulting crispy texture. The modified waxy corn starch used in the present invention is preferably UltraCrisp CS starch, available from National Starch, headquartered in Bridgewater, N.J., but can be any modified starch that aids final product expansion such as X-PAND'R Starch available from AE Staley Manufacturing Company, headquartered in London, U.K.

In yet another embodiment, tapioca starch is included as an additional ingredient in the binder mixture. Tapioca starch is produced from treated and dried cassaya root. It is relatively inexpensive, neutral in flavor and contributes to the dough cohesiveness and an expanded texture and structure in the finished product. The tapioca starch used in the present invention is preferably native tapioca starch available from Avebe Food, but can be any similar, neutral starch.

In still another embodiment of the present invention, vital wheat gluten is included as a binder mixture ingredient. Vital wheat gluten is a powderized form of wheat gluten, which contains about 75% to about 85% of the protein found in whole wheat kernels. The vital wheat gluten used in this invention is preferably Amygluten 110, from AE Staley Manufacturing Company, headquartered in London, U.K., but can be any wheat gluten. Vital wheat gluten is difficult to process at high levels, but when used at appropriate levels, it gives the dough elasticity and cohesiveness during sheeting. Vital wheat gluten is also included as an ingredient to increase the protein content of the final snack chip and contribute to its texture and structural integrity.

Other ingredients that can optionally be included in the snack chips of the present invention include potato flakes (for improved texture), protein isolates, including soy, whey or wheat isolates (as an additional protein source), sugar and salt (for improved flavor), monocalcium phosphate, sodium bicarbonate and/or ammonium bicarbonate (as leavening agents), and soy lecithin powder or mono- or di-glycerides (as an emulsifier). Still more ingredients can be included within the scope of the present invention to enhance the taste, appearance or structure of the snack chip.

In one preferred embodiment of the nut-based snack chips of the present invention, water is mixed with the nut particles, binder mixture and other dry ingredients to make a nut-based dough. The resultant dough comprises about 31% to about 50% nut particles, about 10% to about 30% wheat flour, about 10% to about 40% starch, about 2% to about 10% wheat gluten, and about 20% to about 32% added water. In a most preferred embodiment, the resultant dough comprises about 40% to about 50% nut particles, about 18% to about 25% wheat flour, about 18% to about 25% starch, about 5% to about 8% wheat gluten, and about 20% to about 32% added water.

In a more preferred embodiment, the starch component comprises, as a weight percentage of the total dough weight, about 7% to about 14% modified starch and about 7% to about 14% native starch. In a more preferred embodiment the wheat gluten comprises vital wheat gluten.

In a more preferred embodiment, the nut particles comprise full fat, dry roasted, blanched pieces of peanuts, preferably having a particle a size distribution profile comprising about 5% to about 60% passing through a U.S. #6 mesh screen, about 20% to about 40% passing through a U.S. #8 mesh screen, about 20% to about 35% passing through a U.S. #10 mesh screen. In a most preferred embodiment, the peanut pieces have a size distribution profile comprising about 52% passing through a U.S. #6 mesh screen, about 25% passing through a U.S. #8 mesh screen, and about 23% passing through a U.S. #10 mesh screen. In another more preferred embodiment, the pieces of peanut comprise slices of peanut, having a slice thickness between about 0.043 inches and about 0.060 inches.

In a more preferred embodiment, the nut particles comprise full fat, raw pieces of chopped pistachio nuts, most preferably having a particle distribution comprising about 30% to about 60% passing through a U.S. #6 mesh screen, about 30% to about 50% passing through a U.S. #8 mesh screen, and about 10% to about 30% passing through a U.S. #10 mesh screen. In a most preferred embodiment, the pieces of chopped pistachio nuts have a particle size distribution comprising about 40% passing through a U.S. #6 mesh screen, about 40% passing through a U.S. #8 mesh screen, and about 20% passing through a U.S. #110 mesh screen.

In another more preferred embodiment, the pieces of pistachio nuts are sliced pistachio nuts, having a preferred thickness between about 0.043 inches and about 0.060 inches.

In yet another a preferred embodiment, the nut particles comprise full fat, natural, raw, sliced almonds, most preferably having a slice thickness between about 0.043 inches and about 0.060 inches.

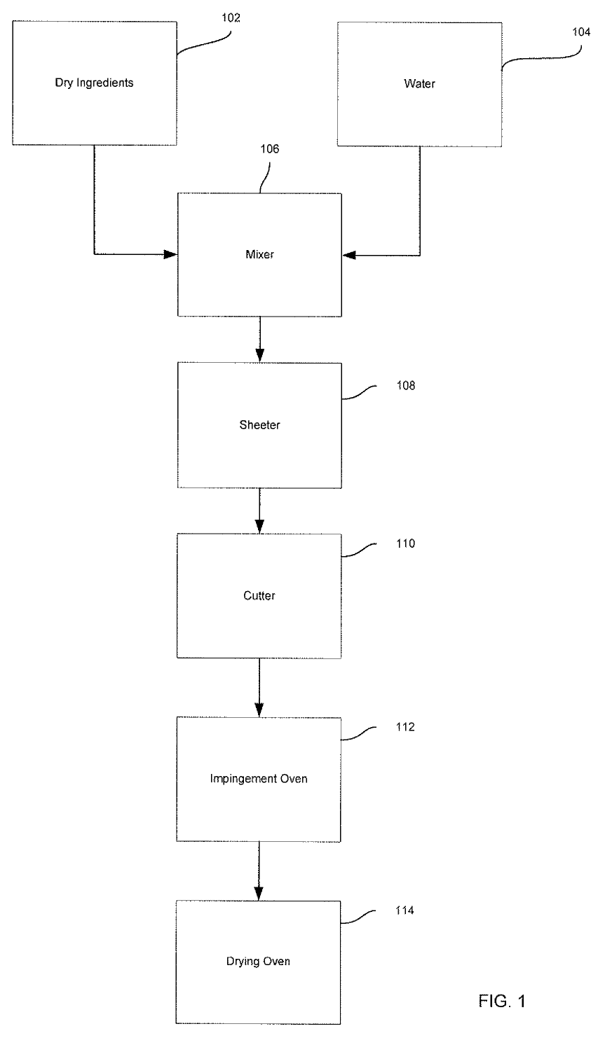

Referring to FIG. 1, therein is depicted a flowchart indicating the general processing steps for producing the nut-based snack chips of the present invention. In the first processing step, the dry ingredients 102 are mixed with water 104 in a continuous, batch or other mixer 106 to produce a dough. The mixing preferably occurs at ambient temperature, generally about 60° F. to about 95° F., and the dough exits the mixer between about 65° F. and about 85° F.

The dough then undergoes a sheeting step 108, whereby the dough is compressed between at least one pair of counter rotating sheeter/cutter rollers that are located closely together, thereby providing a pinch point through which the dough is formed into sheets. The sheet of dough is preferably between about 1 millimeter and about 1.4 millimeters thick, and more preferably about 1.2 millimeters thick after the sheeting step. The targeted thickness is preferably accomplished by passing the dough through several successive stages of rollers, with each successive stage having the rollers located progressively closer together, more preferably 2, 3 or 4 stages of rollers. Passing the dough through several stages of rollers minimizes the amount of work done on the dough during the sheeting step by any particular set of rollers, thereby reducing the influence of the sheeting step on the physical properties of the dough that are established during the mixing step.

The sheeted dough is then cut into a plurality of pieces 110, preferably using a rotary cutting unit. The pieces are then baked in an air impingement oven 112 at between about 350° F. and about 500° F. to produce partially baked chips having a moisture content between about 7% and about 10% of the total product weight. The partially baked chips are then dried 114 in a drying oven at about 270° F. to a final moisture content between about 1% and about 2%.

The resultant nut-based snack chip in one preferred embodiment comprises about 39% to about 48% nut particles, about 20% to about 29% wheat flour, about 18% to about 27% starch, about 5% to about 12% wheat gluten and less than about 2% water. The resultant nut-based snack chip in a more preferred embodiment comprises about 40% to about 46% nut particles, about 22% to about 25% wheat flour, about 20% to about 25% starch, about 5% to about 12% wheat gluten and less than about 2% water.

### FIRST EXAMPLE

The table below illustrates the ingredients and their relative amounts that were used to make a peanut based chip according to the present invention:

TABLE III

| | Wt. % | Wt. % | Wt. % |
|---|---|---|---|
| Ingredient | Dry Ingredients | Dough | Final Product |
| Nut Pieces | 42.00% | 33.33% | 41.38% |
| Wheat Flour | 22.25% | 17.66% | 21.92% |
| Modified Starch | 10.00% | 7.94% | 9.85% |
| Tapioca Starch | 10.00% | 7.94% | 9.85% |
| Potato Flakes | 2.00% | 1.59% | 1.97% |
| Vital Wheat Gluten | 6.70% | 5.32% | 6.60% |
| Soy Protein Isolate | 0.00% | 0.00% | 0.00% |
| Brown Sugar | 4.50% | 3.57% | 4.43% |
| Salt | 0.50% | 0.40% | 0.49% |
| Monocalcium Phosphate | 0.85% | 0.67% | 0.84% |
| Sodium Bicarbonate | 0.70% | 0.56% | 0.69% |
| Dry Soy Lecithin | 0.50% | 0.40% | 0.49% |
| Water | 0.00% | 26.00% | 1.50% |

In this embodiment, the peanut particle size distribution was as follows: 52% passed through a U.S. #6 mesh screen, 25% passed through a U.S. #8 mesh screen, and 23% passed through a U.S. #10 mesh screen. The peanut pieces and other dry ingredients were combined in a Hobart batch mixer and mixed on low speed for approximately 2 minutes. The water was then added to the dry mixture and mixed on medium speed for about 1 minute. The bottom of the bowl was scraped, and the mixture was mixed on medium speed for an additional 30 seconds to create the dough having a moisture content of about 26%. The dough exited the mixer at between 65° F. and 85° F. The dough was then sheeted using 2 stages of rollers to produce a sheet of dough about 1.2 millimeters thick. The sheet of dough then passed through a rotary cutting step that produced snack sized pieces of dough, each piece having an upper surface area between about 2 square inches and about 5 square inches. The pieces were then baked in a 4 zone air impingement oven, punch-plate type, for about 1 to 2 minutes at 500° F. to 350° F. to produce partially baked snack pieces having a total moisture content between 7% and 10% by weight. The partially baked pieces were then dried in a 1 zone convection drying oven for about 5 to 10 minutes at about 270° F. until the pieces had a final moisture content of about 1.5%.

### SECOND EXAMPLE

The table below illustrates the ingredients and their relative amounts that were used to make a pistachio or almond based snack chip according to the present invention:

TABLE IV

| | Wt. % | Wt. % | Wt. % |
|---|---|---|---|
| Ingredient | Dry Ingredients | Dough | Final Product |
| Nut Pieces | 42.00% | 33.33% | 41.38% |
| Wheat Flour | 22.25% | 17.66% | 21.92% |
| Modified Starch | 10.00% | 7.94% | 9.85% |
| Tapioca Starch | 7.75% | 6.15% | 7.64% |
| Potato Flakes | 2.00% | 1.59% | 1.97% |
| Vital Wheat Gluten | 6.70% | 5.32% | 6.60% |
| Soy Protein Isolate | 2.25% | 1.79% | 2.22% |
| Brown Sugar | 4.50% | 3.57% | 4.43% |
| Salt | 0.50% | 0.40% | 0.49% |
| Monocalcium Phosphate | 0.85% | 0.67% | 0.84% |
| Sodium Bicarbonate | 0.70% | 0.56% | 0.69% |
| Dry Soy Lecithin | 0.50% | 0.40% | 0.49% |
| Water | 0.00% | 26.00% | 1.50% |

In this embodiment, the pieces of almond or pistachio nuts were slices of almond or pistachio having a slice thickness between 0.043 inches and 0.060 inches. The nut slices and dry ingredients were combined in a Hobart batch mixer and mixed on low speed for approximately 2 minutes. The water was then added to the dry mixture and mixed on medium speed for about 1 minute. The bottom of the bowl was scraped, and the mixture was mixed on medium speed for an additional 30 seconds to create the dough having a moisture content of about 26%. The dough exited the mixer at between 65° F. and 85° F. The dough was then sheeted using 2 stages of rollers to produce a sheet of dough about 1.2 millimeters thick. The sheet of dough then passed through a rotary cutting step that produced snack sized pieces of dough, each piece having an upper surface area between about 2 square inches and about 5 square inches. The pieces were then baked in a 4 zone air impingement oven, punch-plate type, for about 1 to 2 minutes at 500° F. to 350° F. to produce partially baked snack pieces having a total moisture content between 7% and 10% by weight. The partially baked pieces were then dried in a 1 zone convection drying oven for about 5 to 10 minutes at about 270° F. until the pieces had a final moisture content of about 1.5%.

While the above examples disclose some batch operations, it should be understood that the present invention can also comprise a continuous process throughout each unit step.

The nut-based snack chips described in the above examples exhibit a crispy, crunchy texture and structural integrity that allows them to survive shipment with minimal breakage. In addition, the nut-based snack chips disclosed herein meet or exceed the other preferred nutritional goals discussed above. Specifically, the snack chips disclosed deliver, per 30 gram serving, at least 11 grams of nuts, less than 7.5 grams of fat, no more than 1 gram of saturated fat, no more than 270 milligrams of sodium, no more than 20 milligrams of cholesterol, and at least 10% FDA recommended daily value of protein. In sum, the result is a healthy, nutritious nut-based snack chip having a crispy, crunchy texture, visible pieces of nuts, and improved structural integrity.

What is claimed is:

1. A nut-based dough comprising by weight:
about 31% to about 50% nut particles;
about 10% to about 30% wheat flour;
about 10% to about 40% starch;
about 2% to about 10% wheat gluten; and
about 20% to about 32% added water.

2. The dough of claim 1 wherein said nut particles comprise pieces of peanut.

3. The dough of claim 2 wherein said pieces of peanut have a particle size distribution as follows:
about 5% to about 60% pass through a U.S. #6 mesh screen;
about 20% to about 40% pass through a U.S. #8 mesh screen;
about 20% to about 35% pass through a U.S. #10 mesh screen.

4. The dough of claim 2 wherein said pieces of peanut have a particle size distribution as follows:
about 52% pass through a U.S. #6 mesh screen;
about 25% pass through a U.S. #8 mesh screen; and
about 23% pass through a U.S. #10 mesh screen.

5. The dough of claim 2 wherein said pieces of peanut comprise pieces of full fat, dry roasted, blanched peanuts.

6. The dough of claim 2 wherein said pieces of peanut comprise slices of peanut having a thickness between about 0.043 inches and about 0.060 inches.

7. The dough of claim 1 wherein said nut particles comprise pieces of pistachio nut.

8. The dough of claim 7 wherein said pieces of pistachio nut have a particle size distribution as follows:
about 30% to about 60% pass through a U.S. #6 mesh screen;
about 30% to about 50% pass through a U.S. #8 mesh screen; and
about 10% to about 30% pass through a U.S. #10 mesh screen.

9. The dough of claim 7 wherein said pieces of pistachio nut have a particle size distribution as follows:
about 40% pass through a U.S. #6 mesh screen;
about 40% pass through a U.S. #8 mesh screen; and
about 20% pass through a U.S. #10 mesh screen.

10. The dough of claim 7 wherein said pieces of pistachio nut comprise slices of pistachio nut having a thickness between about 0.043 inches and about 0.060 inches.

11. The dough of claim 7 wherein said pieces of pistachio nut comprise pieces of full fat, raw pistachio nuts.

12. The dough of claim 1 wherein said nut particles comprise pieces of almond.

13. The dough of claim 12 wherein said pieces of almond are slices of almond having a slice thickness between about 0.043 inches and about 0.060 inches.

14. The dough of claim 12 wherein said pieces of almond are pieces of full fat, natural, raw almonds.

15. The dough of claim 1 wherein said starch comprises, as a percentage of the total dough weight:
about 7% to about 14% modified starch; and
about 7% to about 14% native starch.

16. The dough of claim 15 wherein said modified starch comprises a modified waxy corn starch.

17. The dough of claim 15 wherein said native starch comprises a tapioca starch.

18. The dough of claim 1 wherein said wheat flour comprises pastry wheat flour.

19. The dough of claim 1 wherein said wheat gluten comprises vital wheat gluten.

20. A nut-based snack chip comprising, by weight:
about 37% to about 48% nut particles;
about 20% to about 29% wheat flour;
about 18% to about 27% starch;
about 5% to about 12% wheat gluten; and
less than about 2% water.

21. The snack chip of claim 20 wherein said wheat flour comprises pastry flour.

22. The snack chip of claim 20 wherein said wheat gluten comprises vital wheat gluten.

23. The snack chip of claim 20 wherein said starch comprises, as a percentage of total dough weight:
about 9% to about 13% modified starch; and
about 9% to about 13% native starch.

24. The snack chip of claim 23 wherein said modified starch comprises a modified waxy corn starch.

25. The snack chip of claim 23 wherein said native starch comprises a tapioca starch.

26. The snack chip of claim 20 wherein said nut particles comprise pieces of peanut.

27. The snack chip of claim 26 wherein said pieces of peanut have a particle size distribution as follows:
about 5% to about 60% pass through a U.S. #6 mesh screen;
about 20% to about 40% pass through a U.S. #8 mesh screen;
about 20% to about 35% pass through a U.S. #10 mesh screen.

28. The snack chip of claim 26 wherein said pieces of peanut have a particle size distribution as follows:
about 52% pass through a U.S. #6 mesh screen;
about 25% pass through a U.S. #8 mesh screen; and
about 23% pass through a U.S. #10 mesh screen.

29. The snack chip of claim 26 wherein said pieces of peanut comprise slices of peanut having a thickness between about 0.043 inches and about 0.060 inches.

30. The snack chip of claim 26 wherein said pieces of peanut comprise pieces of full fat, dry roasted, blanched peanuts.

31. The snack chip of claim 20 wherein said nut particles comprise pieces of pistachio nut.

32. The snack chip of claim 31 wherein said pieces of pistachio nut have a particle size distribution as follows:
about 30% to about 60% pass through a U.S. #6 mesh screen;
about 30% to about 50% pass through a U.S. #8 mesh screen; and
about 10% to about 30% pass through a U.S. #10 mesh screen.

33. The snack chip of claim 31 wherein said pieces of pistachio nut have a particle size distribution as follows:
about 40% pass through a U.S. #6 mesh screen;
about 40% pass through a U.S. #8 mesh screen; and
about 20% pass through a U.S. #10 mesh screen.

34. The snack chip of claim 31 wherein said pieces of pistachio nut comprise slices of pistachio nut having a thickness between about 0.043 inches and about 0.060 inches.

35. The snack chip of claim 31 wherein said pieces of pistachio nut comprise pieces of full fat, raw pistachio nuts.

36. The snack chip of claim 20 wherein said nut particles comprise pieces of almond.

37. The snack chip of claim 36 wherein said pieces of almond comprise slices of almond having a slice thickness between about 0.043 inches and about 0.060 inches.

38. The snack chip of claim 36 wherein said pieces of almond are pieces of full fat, natural, raw almonds.

39. The snack chip of claim 20 additionally comprising, per 30 grams of snack chips:
at least 11 grams of nuts;
at least 5 grams of protein;
less than 7.5 grams of fat;
no more than 1 grain of saturated fat;
no more than 270 milligrams of sodium; and
no more than 20 milligrams of cholesterol.

40. A method for making a nut-based snack chip, said method comprising the steps of:
a. mixing dry ingredients and water to make a dough, wherein said dough comprises by weight:
about 31% to about 50% nut particles;
about 10% to about 30% wheat flour;
about 10% to about 40% starch;
about 2% to about 10% wheat gluten; and
about 20% to about 32% added water;
b. forming said dough into a sheet;
c. cutting said sheet into a plurality of pieces; and
d. cooking each said piece to make a snack chip having moisture content of between about 1% to about 2% by weight.

41. The method of claim 40 wherein said nut particles comprise pieces of peanut.

42. The method of claim 41 wherein said pieces of peanut have a particle size distribution as follows:
about 5% to about 60% pass through a U.S. #6 mesh screen;
about 20% to about 40% pass through a U.S. #8 mesh screen;
about 20% to about 35% pass through a U.S. #10 mesh screen.

43. The method of claim 41 wherein said pieces of peanut have a particle size distribution as follows:
about 52% pass through a U.S. #6 mesh screen;
about 25% pass through a U.S. #8 mesh screen; and
about 23% pass through a U.S. #10 mesh screen.

44. The method of claim 41 wherein said pieces of peanut comprise slices of peanut having a thickness between about 0.043 inches and about 0.060 inches.

45. The method of claim 41 wherein said pieces of peanut comprise pieces of full fat dry roasted, blanched peanuts.

46. The method of claim 40 wherein said nut particles comprise pieces of pistachio nut.

47. The method of claim 46 wherein said pieces of pistachio nut have a particle size distribution as follows:
about 30% to about 60% pass through a U.S. #6 mesh screen;
about 30% to about 50% pass through a U.S. #8 mesh screen; and
about 10% to about 30% pass through a U.S. #10 mesh screen.

48. The method of claim 46 wherein said pieces of pistachio nut have a particle size distribution as follows:
about 40% pass through a U.S. #6 mesh screen;
about 40% pass through a U.S. #8 mesh screen; and
about 20% pass through a U.S. #10 mesh screen.

49. The method of claim 46 wherein said pieces of pistachio nut comprise slices of pistachio nut having a thickness between about 0.043 inches and about 0.060 inches.

50. The method of claim 46 wherein said pieces of pistachio nut comprise pieces of full fat, raw, unsalted pistachio nuts.

51. The method of claim 40 wherein said nut particles comprise pieces of almond.

52. The method of claim 51 wherein said pieces of almond comprise slices of almond having a slice thickness between about 0.043 inches and about 0.060 inches.

53. The method of claim 51 wherein said pieces of almond comprise pieces of full fat, natural, raw almonds.

54. The method of claim 40 wherein said starch comprises, as a percentage of the total dough weight:
about 7% to about 14% modified starch; and
about 7% to about 14% native starch.

55. The method of claim 54 wherein said modified starch comprises a modified waxy corn starch.

56. The method of claim 54 wherein said native starch comprises a tapioca starch.

57. The method of claim 40 wherein said wheat flour comprises pastry wheat flour.

58. The method of claim 40 wherein said wheat gluten comprises vital wheat gluten.

59. The method of claim 40 wherein said cooking step comprises:
baking each said piece in an air impingement oven at between about 500° F. and about 350° F. to produce a partially baked snack piece having a total moisture content between about 7% and about 10% by weight;
drying each said partially baked snack piece in a convection drying oven at about 270° F. to make a snack chip having a moisture content of about 1.5% by weight.

60. A snack chip produced by the method of claim 40.
